(19) United States
(12) Patent Application Publication
(10) Pub. No.: US 2006/0067264 A1
(43) Pub. Date: Mar. 30, 2006

(54) Method and apparatus to provide selective status information for communications channel(s)

(76) Inventor: Jeffrey A. Whaley, Dripping Springs, TX (US)

Correspondence Address: DAVIS & ASSOCIATES, P.O. BOX 1093, DRIPPING SPRINGS, TX, 78620, US

(21) Appl. No.: 10/955,951

(22) Filed: Sep. 30, 2004

(51) Int. Cl. H04B 7/212

(52) U.S. Cl. 370/321

(57) ABSTRACT

An integrated circuit maintains status information for a communications channel. The integrated circuit selects a portion of the status information maintained for the communications channel. The integrated circuit repeatedly transmits the selected portion of status information over a time-division multiplexed channel to a host.

### BACKGROUND

Subscriber line (or loop) interface circuitry (SLIC) may be found in or near a central office exchange of a telecommunications network.

One SLIC provides a communications interface between a digital switching network for a central office exchange and an analog subscriber line. The analog subscriber line connects to subscriber equipment, such as a subscriber station or telephonic instrument for example, at a location remote from the central office exchange. The analog subscriber line and subscriber equipment form a subscriber loop.

The SLIC detects and transforms voiceband communications transmitted from the subscriber equipment in the form of low voltage analog signals on the subscriber loop into corresponding digital data for transmission to the digital switching network. For bidirectional communication, the SLIC also transforms digital data received from the digital switching network into corresponding low voltage analog signals for transmission on the subscriber loop to the subscriber equipment.

One dual SLIC provides a dual-channel analog telephone interface and supports a General Circuit Interface (GCI) for the transmission and reception of both control and data information onto a GCI bus coupled to a digital switching network. The GCI interface provides a Signaling and Control (SC) channel for communicating limited, predetermined status information about each analog telephone channel to the digital switching network.

### SUMMARY

One disclosed method comprises maintaining by an integrated circuit status information for a communications channel, selecting by the integrated circuit a portion of the status information maintained for the communications channel, and repeatedly transmitting by the integrated circuit the selected portion of status information over a time-division multiplexed channel to a host.

One disclosed apparatus comprises circuitry to maintain status information for a communications channel, circuitry to select a portion of the status information maintained for the communications channel, and circuitry to transmit repeatedly the selected portion of status information over a time-division multiplexed channel to a host.

One disclosed system comprises a subscriber line interface circuitry integrated circuit for coupling to a host and comprises a plurality of linefeed interface integrated circuits for coupling to the subscriber line interface circuitry integrated circuit and to a plurality of subscriber loops. The subscriber line interface circuitry integrated circuit comprises circuitry to maintain status information for one or more of the subscriber loops, circuitry to select a portion of the maintained status information, and circuitry to transmit repeatedly the selected portion of status information over a time-division multiplexed channel to the host.

### BRIEF DESCRIPTION OF THE DRAWINGS

One or more described embodiments are illustrated by way of example and not limitation in the figures of the accompanying drawings, in which like references indicate similar elements and in which:

FIG. 1 illustrates, for one or more embodiments, a communications channel(s) interface integrated circuit to help provide selective status information for one or more communications channels to a host;

FIG. 2 illustrates, for one or more embodiments, a flow diagram to help provide selective status information for one or more communications channels to a host;

FIG. 3 illustrates, for one or more embodiments, example circuitry to select status information for the communications channel(s) interface integrated circuit of FIG. 1;

FIG. 4 illustrates, for one or more embodiments, a subscriber line interface circuitry (SLIC) integrated circuit to help provide selective status information for one or more subscriber loops to a host;

FIG. 5 illustrates, for one or more embodiments, a flow diagram to help provide selective status information for one or more subscriber loops to a host; and

FIG. 6 illustrates, for one or more embodiments, an example General Circuit Interface (GCI) frame structure to help provide selective status information for one or more communications channels to a host.

### DETAILED DESCRIPTION

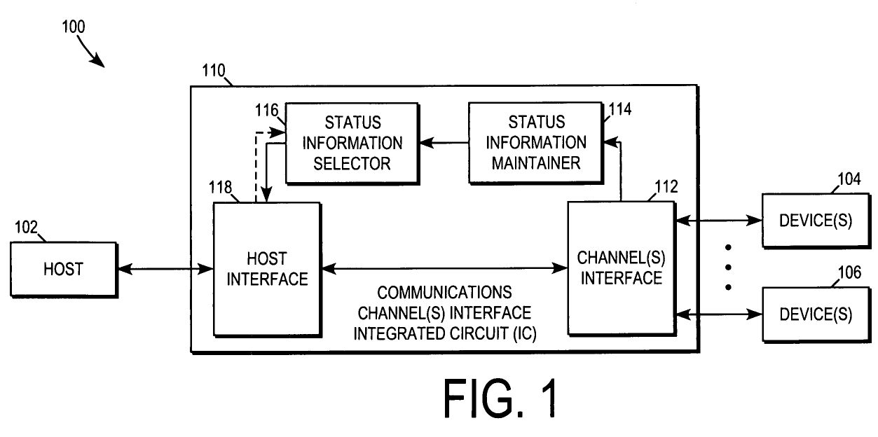

FIG. 1 illustrates, for one or more embodiments, a system 100 comprising a communications channel(s) interface integrated circuit 110 for coupling between a host 102 and one or more devices, such as one or more devices 104 and/or one or more devices 106 for example. Integrated circuit 110 provides an interface for host 102 to communicate with one or more devices over one or more communications channels.

Integrated circuit 110 for one or more embodiments may comprise any suitable circuitry to help provide any suitable status information for one or more communications channels to host 102 in a selective manner. Integrated circuit 110 for one or more embodiments may therefore help host 102 monitor the status of one or more communications channels as desired.

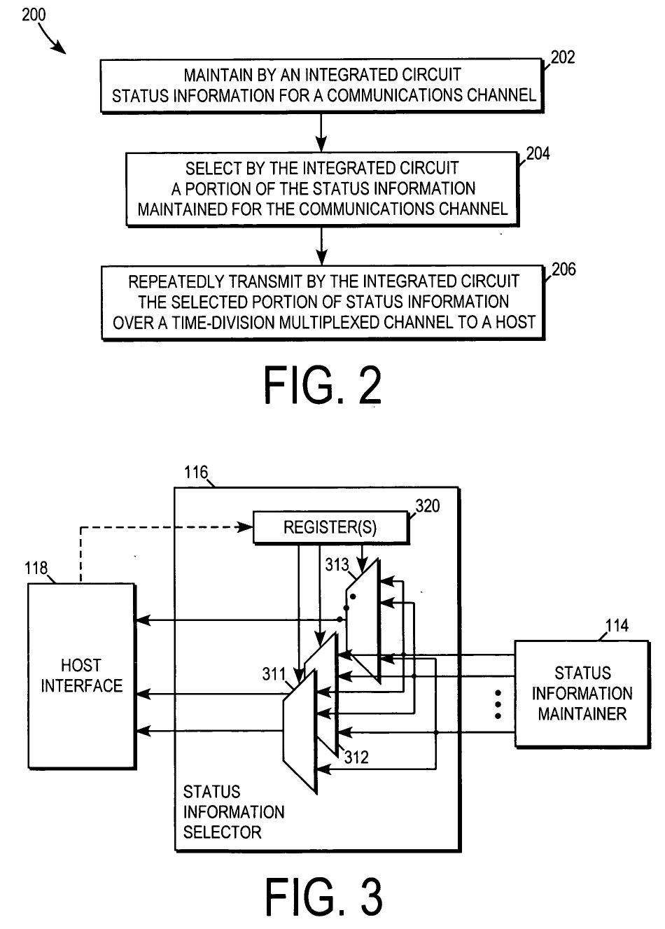

Integrated circuit 110 for one or more embodiments may help provide selective status information for one or more communications channels to host 102 in accordance with a flow diagram 200 of FIG. 2.

For block 202 of FIG. 2, integrated circuit 110 maintains status information for a communications channel. Integrated circuit 110 may maintain any suitable status information for any suitable communications channel in any suitable manner.

Integrated circuit 110 for one or more embodiments, as illustrated in FIG. 1, may comprise a channel(s) interface 112 for integrated circuit 110 to communicate over one or more communications channels with one or more devices, such as one or more devices 104 and/or one or more devices 106 for example. Channel(s) interface 112 may be implemented using any suitable circuitry, including any suitable hardware, software, and/or firmware, to provide an interface for integrated circuit 110 to communicate over any suitable number of any suitable communications channel(s) in any suitable manner.

Integrated circuit 110 for one or more embodiments, as illustrated in FIG. 1, may also comprise a status information maintainer 114 coupled to channel(s) interface 112 to maintain status information for one or more communications channels over which integrated circuit 110 may communicate using channel(s) interface 112. Status information maintainer 114 may be implemented using any suitable circuitry, including any suitable hardware, software, and/or firmware, to identify a status of any suitable conditions of any suitable one or more communications channels and maintain any suitable status information to identify the status of such conditions. For one or more embodiments where integrated circuit 110 helps provide an interface to one or more subscriber loops, status information maintainer 114 for one or more embodiments may maintain, for example, interrupt status information, hook status information, ground key status information, and/or ring trip status information for one or more subscriber loops. Status information maintainer 114 for one or more embodiments may maintain any suitable number of one or more status bits each of which identifies the status of a condition of a communications channel.

For block 204 of FIG. 2, integrated circuit 110 selects a portion of the status information maintained for block 202. Integrated circuit 110 may select any suitable portion of the status information maintained for block 202 in any suitable manner.

Integrated circuit 110 for one or more embodiments, as illustrated in FIG. 1, may comprise a status information selector 116 coupled to status information maintainer 114 to select a portion of the status information maintained by status information maintainer 114 for any suitable one or more communications channels. Status information selector 116 may be implemented using any suitable circuitry, including any suitable hardware, software, and/or firmware, to select any suitable portion of the status information maintained by status information maintainer 114 in any suitable manner. For one or more embodiments where status information maintainer 114 maintains status bits each of which identifies the status of a condition of a communications channel, status information selector 116 for one or more embodiments may select a predetermined number of such status bits for a communications channel. Status information selector 116 for one or more embodiments may select at most a predetermined number of such status bits for a communications channel.

For block 206 of FIG. 2, integrated circuit 110 repeatedly transmits the selected portion of status information over a time-division multiplexed channel to host 102. Integrated circuit 110 may repeatedly transmit the selected portion of status information over a time-division multiplexed channel to host 102 in any suitable manner.

Integrated circuit 110 for one or more embodiments, as illustrated in FIG. 1, may comprise a host interface 118 for integrated circuit 110 to communicate with host 102 over one or more time-multiplexed channels. Host interface 118 may be implemented using any suitable circuitry, including any suitable hardware, software, and/or firmware, to provide an interface for integrated circuit 110 to communicate with host 102 over any suitable one or more time-multiplexed channels in any suitable manner. Host interface 118 may be coupled to receive the selected portion of status information from status information selector 116 in any suitable manner for transmission to host 102. Host interface 118 may also be coupled to channel(s) interface 112 in any suitable manner to allow host 102 to communicate over one or more communications channels with one or more devices using channel(s) interface 112.

Repeatedly transmitting the selected portion of maintained status information over a time-division multiplexed channel to host 102 for one or more embodiments may help host 102 monitor the status of one or more communications channels in real-time or in substantially real-time while host 102 communicates with integrated circuit 110 over one or more other time-division multiplexed channels to communicate with, for example, device(s) 104 and/or device(s) 106.

Host interface 118 for one or more embodiments may be a General Circuit Interface (GCI) for integrated circuit 110 to communicate with host 102 over a GCI bus coupled to host interface 118 and host 102. Host interface 118 for one or more embodiments may transmit the selected portion of status information over a Signaling and Control (SC) channel for the GCI interface.

Integrated circuit 110 may perform operations for blocks 202-206 in any suitable order and may or may not overlap in time the performance of any suitable operation with any other suitable operation. Integrated circuit 110 for one or more embodiments may, for example, continue to maintain status information for block 202 as integrated circuit 110 performs operations for blocks 204 and 206. Integrated circuit 110 for one or more embodiments may overlap in time the performance of operations for blocks 202-206 for multiple communications channels.

Integrated circuit 110 for one or more embodiments may receive from host 102 one or more commands identifying the portion of status information to be selected for block 204. For one or more embodiments, as illustrated in FIG. 1, host interface 118 may receive such command(s) from host 102 and may be coupled to help identify to status information selector 116 the portion of status information to be selected. Integrated circuit 110 for one or more embodiments may comprise any other suitable circuitry, including any suitable hardware, software, and/or firmware, to help identify to status information selector 116 the portion of status information to be selected.

Enabling host 102 and/or integrated circuit 110 to help select a portion of status information for transmission to host 102 helps allow a user to have host 102 monitor the status of one or more communications channels as desired. Integrated circuit 110 for one or more embodiments may comprise any suitable circuitry, including any suitable hardware, software, and/or firmware, to enable host 102 and/or integrated circuit 110 to help select a portion of status information dynamically for transmission to host 102 to help increase the amount of status information available for monitoring by host 102.

Status information selector 116 for one or more embodiments, as illustrated in FIG. 3, may comprise one or more multiplexers, such as multiplexers 311, 312, and 313 for example, coupled to receive status information maintained by status information maintainer 114 for a communications channel and to output a portion of such received status information selectively to host interface 118. Status information selector 116 may comprise any suitable number of one or more multiplexers to receive any suitable amount of status information for a communications channel and to output any suitable portion of received status information selectively in any suitable manner.

Status information selector 116 for one or more embodiments, as illustrated in FIG. 3, may comprise a plurality of multiplexers each of which is coupled to receive a same set of a plurality of status bits for a communications channel from status information maintainer 114 and to output one of the status bits selectively from the set to host interface 118. As one example, status information selector 116 for one or more embodiments may comprise three multiplexers each of which is coupled to receive a same set of eight status bits for a communications channel from status information maintainer 114 and to output one of the eight status bits to host interface 118. Status information selector 116 for this example may therefore select three of eight status bits for a communications channel for transmission to host 102.

Status information selector 116 for one or more embodiments may comprise a plurality of multiplexers two or more of which are coupled to receive different sets of status bits for a communications channel from status information maintainer 114. Such multiplexers for one or more embodiments may each selectively output one of its received status bits to host interface 118.

Status information selector 116 for one or more embodiments, as illustrated in FIG. 3, may also comprise one or more latches and/or one or more registers, such as a register(s) 320 for example, coupled to receive, store, and output one or more signals to control one or more multiplexers to output a select portion of status information to host interface 118. Such latch(es) and/or register(s) for one or more embodiments may be coupled to host interface 118 to receive such control signal(s) from host interface 118 in response to one or more commands received from host 102. Such latch(es) and/or register(s) for one or more embodiments may be coupled to any other suitable circuitry of integrated circuit 110 to receive such control signals.

Although described and illustrated as comprising multiplexer(s) to help select a portion of status information for one communications channel, status information selector 116 for one or more embodiments may also comprise suitable circuitry, such as one or more multiplexers for example, to help select a portion of status information for one or more other communications channels.

SLIC Integrated Circuit

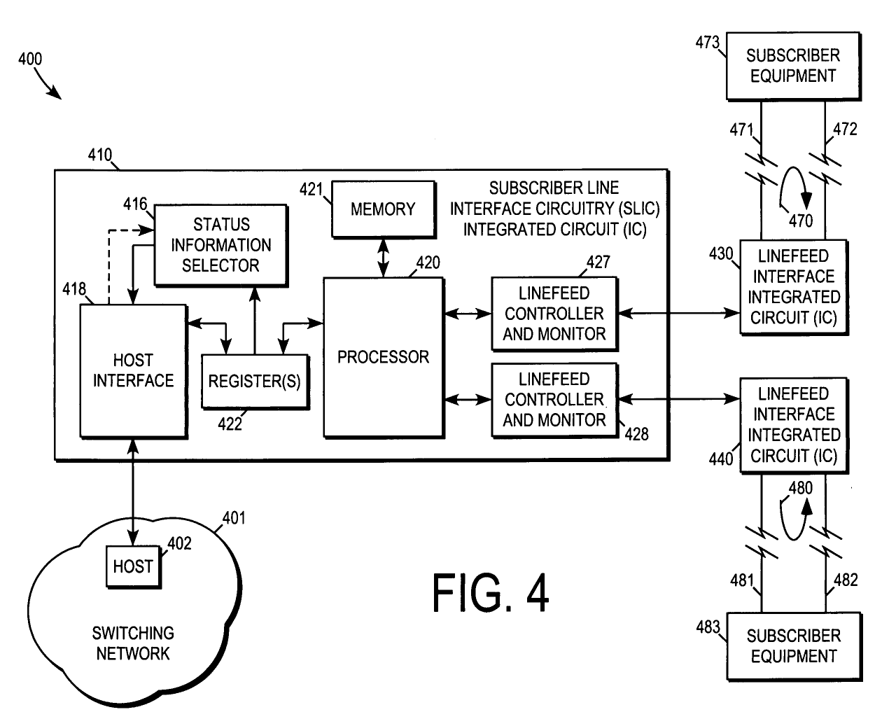

FIG. 4 illustrates, for one or more embodiments, a system 400 comprising a subscriber line interface circuitry (SLIC) integrated circuit 410 for coupling between a host 402 of a switching network 401 and subscriber equipment, such as subscriber equipment 473 and 483 for example, on one or more subscriber loops, such as subscriber loops 470 and 480 for example. Switching network 401 for one or more embodiments may be a digital switching network for a larger telecommunications network, such as the Public Switched Telephone Network (PSTN). Host 402, SLIC integrated circuit 410, and subscriber equipment 473 and 483 generally correspond to host 102, integrated circuit 110, and device(s) 104 and 106, respectively, of FIG. 1.

SLIC integrated circuit 410 for one or more embodiments may be coupled to control one or more linefeed interface integrated circuits, such as linefeed interface integrated circuits 430 and 440 for example, to help provide a communications interface between host 402 and one or more subscriber loops, such as subscriber loops 470 and 480 for example. SLIC integrated circuit 410 and linefeed interface integrated circuits 430 and 440, for example, may be used for any suitable application such as, for example, digital loop carriers; Central Office telephony; pair gain remote terminals; wireless local loop (WLL); digital subscriber line (DSL), coder/decoder (codec), and/or wireless voice-over-broadband systems; cable telephony; private branch exchange (PBX), Internet protocol PBX (IP-PBX), and/or key telephone systems; Integrated Services Digital Network (ISDN), Ethernet, and/or Universal Serial Bus (USB) terminal adapters; and/or Integrated Voice and Data (IVD) systems.

Subscriber loop 470 for one embodiment, as illustrated in FIG. 4, is defined by a first line 471, a second line 472, and subscriber equipment 473. For one embodiment where SLIC integrated circuit 410 and linefeed interface integrated circuit 430 provide an analog telephone interface, first line 471 is called a tip line and second line 472 is called a ring line. Subscriber equipment 473 may be electrically coupled to first line 471 and second line 472 and may comprise any suitable number of devices comprising any suitable circuitry to transmit and receive any suitable signals over first line 471 and second line 472 in any suitable manner. Subscriber equipment 473 for one embodiment may comprise any suitable customer premises equipment (CPE), such as an analog telephone for example.

SLIC integrated circuit 410 and linefeed interface integrated circuit 430 for one embodiment may be coupled to receive signals on subscriber loop 470 from subscriber equipment 473 and forward the received signals or transform and transmit the received signals to switching network 401. SLIC integrated circuit 410 and linefeed interface integrated circuit 430 for one embodiment may be coupled to receive signals from switching network 401 and forward the received signals or transform and transmit the received signals on subscriber loop 470 to subscriber equipment 473. For one embodiment where SLIC integrated circuit 410 and linefeed interface integrated circuit 430 provide an analog telephone interface to subscriber loop 470 and where switching network 401 is a digital switching network, SLIC integrated circuit 410 and linefeed interface integrated circuit 430 may receive voiceband communications transmitted from subscriber equipment 473 in the form of low voltage analog signals on subscriber loop 470 and transform them into corresponding digital data signals for transmission to switching network 401. SLIC integrated circuit 410 and linefeed interface integrated circuit 430 for one embodiment may also transform digital data signals received from switching network 401 into corresponding low voltage analog signals for transmission on subscriber loop 470 to subscriber equipment 473.

Subscriber loop 480 for one embodiment, as illustrated in FIG. 4, is defined by a first line 481, a second line 482, and subscriber equipment 483. For one embodiment where SLIC integrated circuit 410 and linefeed interface integrated circuit 430 provide an analog telephone interface, first line 481 is called a tip line and second line 482 is called a ring line. Subscriber equipment 483 may be electrically coupled to first line 481 and second line 482 and may comprise any suitable number of devices comprising any suitable circuitry to transmit and receive any suitable signals over first line 481 and second line 482 in any suitable manner. Subscriber equipment 483 for one embodiment may comprise any suitable customer premises equipment (CPE), such as an analog telephone for example.

SLIC integrated circuit 410 and linefeed interface integrated circuit 440 for one embodiment may be coupled to receive signals on subscriber loop 480 from subscriber equipment 483 and forward the received signals or transform and transmit the received signals to switching network 401. SLIC integrated circuit 410 and linefeed interface integrated circuit 440 for one embodiment may be coupled to receive signals from switching network 401 and forward the received signals or transform and transmit the received signals on subscriber loop 480 to subscriber equipment 483. For one embodiment where SLIC integrated circuit 410 and linefeed interface integrated circuit 440 provide an analog telephone interface to subscriber loop 480 and where switching network 401 is a digital switching network, SLIC integrated circuit 410 and linefeed interface integrated circuit 440 may receive voiceband communications transmitted from subscriber equipment 483 in the form of low voltage analog signals on subscriber loop 480 and transform them into corresponding digital data signals for transmission to switching network 401. SLIC integrated circuit 410 and linefeed interface integrated circuit 440 for one embodiment may also transform digital data signals received from switching network 401 into corresponding low voltage analog signals for transmission on subscriber loop 480 to subscriber equipment 483.

SLIC integrated circuit 410 for one or more embodiments may be a relatively low voltage device and may be coupled to control linefeed interface integrated circuit 430 and/or 440 to help control relatively higher voltages to operate subscriber equipment 473 and/or 483, respectively. SLIC integrated circuit 410 for one embodiment may comprise any suitable circuitry, including any suitable hardware, software, and/or firmware, to perform any suitable one or more BORSCHT functions and/or any other suitable one or more functions. BORSCHT is an acronym for battery feed, overvoltage protection, ring, supervision, coder/decoder (codec), hybrid, and test.

SLIC integrated circuit 410 for one or more embodiments, as illustrated in FIG. 4, may comprise a host interface 418 for SLIC integrated circuit 410 to communicate with host 402, a processor 420, memory 421 coupled to processor 420 to store instructions and/or data for processor 420, and register(s) 422 coupled to host interface 418. Processor 420 for one or more embodiments may be a digital signal processor (DSP). Memory 421 may comprise any suitable memory, such as random access memory (RAM) and/or read only memory (ROM) for example.

SLIC integrated circuit 410 for one or more embodiments, as illustrated in FIG. 4, may comprise one or more linefeed controllers and monitors, such as linefeed controller and monitor 427 and 428 for example, coupled to processor 420 and to be coupled to one or more linefeed interface integrated circuits, such as linefeed interface integrated circuits 430 and 440 for example, to help control and monitor one or more subscriber loops, such as subscriber loops 470 and 480 for example.

Processor 420 executes instructions stored in memory 421 and interfaces with host interface 418 through register(s) 422 and with linefeed controller and monitor 427 and/or 428 to help forward or transform and transmit signals received from switching network 401 onto subscriber loop 470 and/or 480, respectively, and/or to help forward or transform and transmit signals received from subscriber loop 470 and/or 480, respectively, to switching network 401.

At least a portion of processor 420, at least a portion of memory 421, at least a portion of register(s) 422, linefeed controller and monitor 427, and linefeed controller and monitor 428 generally correspond to channel(s) interface 112 of FIG. 1. Host interface 418 generally corresponds to host interface 118 of FIG. 1.

SLIC integrated circuit 410 for one or more embodiments may comprise any suitable circuitry to help provide any suitable status information for one or more subscriber loops, such as subscriber loops 470 and 480 for example, to host 402 in a selective manner. SLIC integrated circuit 410 for one or more embodiments may therefore help host 402 monitor the status of one or more subscriber loops as desired.

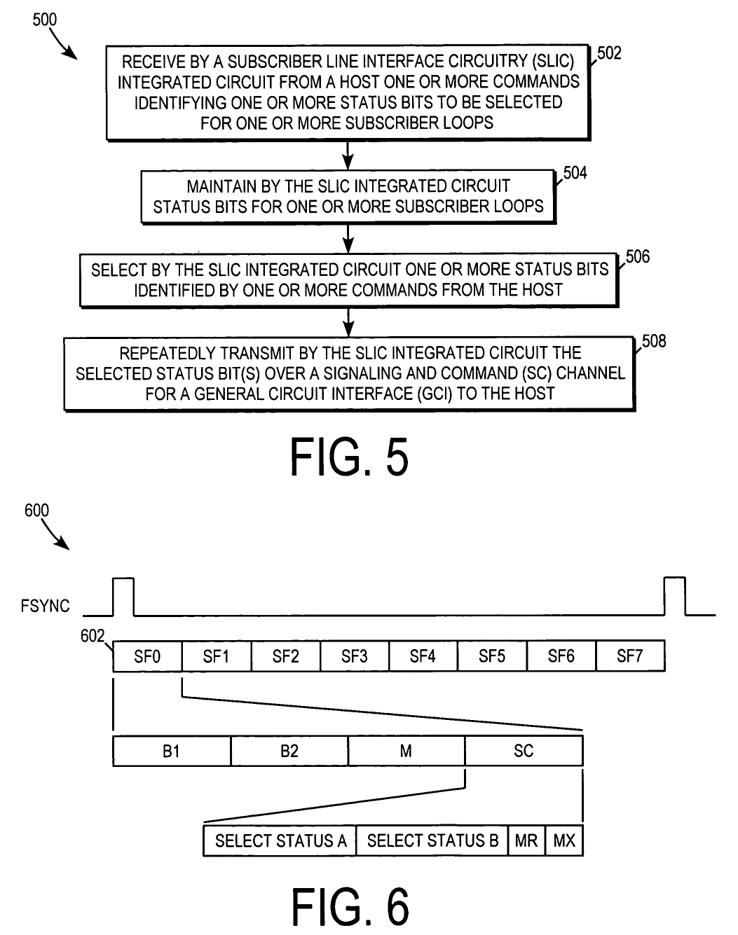

SLIC integrated circuit 410 for one or more embodiments may help provide selective status information for one or more subscriber loops to host 402 in accordance with a flow diagram 500 of FIG. 5.

For block 502 of FIG. 5, SLIC integrated circuit 410 receives from host 402 one or more commands identifying one or more status bits to be selected for one or more subscriber loops. For one or more embodiments, as illustrated in FIG. 4, host interface 418 may receive such command(s) from host 402.

For block 504, SLIC integrated circuit 410 maintains status bits for one or more subscriber loops. SLIC integrated circuit 410 for one or more embodiments, as illustrated in FIG. 4, may comprise a status information maintainer implemented at least in part by processor 420, instructions stored in memory 421, and register(s) 422 to identify a status of any suitable conditions of one or more subscriber loops over which SLIC integrated circuit 410 may communicate and maintain in register(s) 422 any suitable number of any suitable status bits to identify the status of such conditions. Such a status information maintainer for one or more embodiments may maintain, for example, an interrupt presence status bit, a hook status bit, a ground key status bit, a ring trip status bit, and/or a linefeed interface integrated circuit thermal interrupt status bit for one or more subscriber loops. Such a status information maintainer generally corresponds to status information maintainer 114 of FIG. 1.

For block 506, SLIC integrated circuit 410 selects one or more status bits identified by one or more commands from host 402. SLIC integrated circuit 410 for one or more embodiments, as illustrated in FIG. 4, may comprise a status information selector 416 coupled to receive from host interface 418, in response to one or more commands from host 402, one or more control signals identifying one or more status bits to be selected and coupled to register(s) 422 to select the identified status bit(s). Status information selector 416 generally corresponds to status information selector 116 of FIG. 1.

For block 508, SLIC integrated circuit 410 repeatedly transmits the selected status bit(s) over a Signaling and Control (SC) channel for a General Circuit Interface (GCI) to host 402. For one or more embodiments, as illustrated in FIG. 4, status information selector 416 may be coupled to host interface 418 to transmit the selected status bit(s) to host 402.

SLIC integrated circuit 410 for one or more embodiments repeatedly transmits the selected status bit(s) over a Signaling and Control (SC) channel as illustrated in an example General Circuit Interface (GCI) frame structure 600 of FIG. 6.

As illustrated in FIG. 6, a GCI frame 602 is initiated by a pulse on a frame synchronization (FSYNC) signal input to host interface 118 and has a plurality of timeslot subframes (SF0, SF1, SF2, etc.) one of which may be assigned for SLIC integrated circuit 410 to communicate with host 402, for example, by setting one or more inputs to host interface 118. A subframe for SLIC integrated circuit 410, such as subframe SF0 for example, has a plurality of channels such as a voice data channel (B1) for subscriber loop 470, a voice data channel (B2) for subscriber loop 480, a Monitor channel (M) for initialization and setup of SLIC integrated circuit 410, and a Signaling and Command (SC) channel for communicating the status of SLIC integrated circuit 410 and initiating commands.

The SC channel has Command/Indicate (C/I) bits which may be used to carry selected status bits for subscriber loop 470 (SELECT STATUS A) and/or to carry selected status bits for subscriber loop 480 (SELECT STATUS B). The SC channel for one or more embodiments has three Command/Indicate (C/I) bits for subscriber loop 470 (SELECT STATUS A) and three Command/Indicate (C/I) bits for subscriber loop 480 (SELECT STATUS B). The SC channel also has Monitor Receive (MR) and Monitor Transmit (MX) handshaking bits to help exchange data in the Monitor (M) channel.

SLIC integrated circuit 410 for one or more embodiments for block 502 of FIG. 5 may receive from host 402 one or more commands identifying one or more status bits to be selected over the Monitor (M) channel for the General Circuit Interface (GCI) to host 402.

SLIC integrated circuit 410 may perform operations for blocks 502-508 in any suitable order and may or may not overlap in time the performance of any suitable operation with any other suitable operation. SLIC integrated circuit 410 for one or more embodiments may, for example, continue to maintain status information for block 504 as SLIC integrated circuit 410 performs operations for blocks 502, 506, and 508.

Although described in connection with selecting one or more status bits identified by one or more commands from host 402 for blocks 502 and 506, SLIC integrated circuit 410 for one or more embodiments may use processor 420 to help identify to status information selector 116 the one or more status bits to be selected for transmission to host 402. Processor 420 may execute one or more instructions stored in memory 421 to transmit data identifying one or more status bits to be selected to status information selector 116 through register(s) 422. SLIC integrated circuit 410 may use processor 420 to help identify the one or more status bits to be selected in addition to or in lieu of using commands from host 402 for blocks 502 and 506.

In the foregoing description, one or more embodiments of the present invention have been described. It will, however, be evident that various modifications and changes may be made thereto without departing from the broader spirit or scope of the present invention as defined in the appended claims. The specification and drawings are, accordingly, to be regarded in an illustrative rather than a restrictive sense.

What is claimed is:

1. A method comprising:
maintaining by an integrated circuit status information for a communications channel;
selecting by the integrated circuit a portion of the status information maintained for the communications channel; and
repeatedly transmitting by the integrated circuit the selected portion of status information over a time-division multiplexed channel to a host.

2. The method of claim 1, comprising:
receiving by the integrated circuit from the host one or more commands identifying the portion of status information to be selected.

3. The method of claim 1, wherein the selecting comprises selecting a predetermined number of status bits for the communications channel.

4. The method of claim 1, wherein the selecting comprises selecting one or more of interrupt status information, hook status information, ground key status information, and/or ring trip status information.

5. The method of claim 1, comprising:
maintaining by the integrated circuit status information for another communications channel;
selecting by the integrated circuit a portion of the status information maintained for the other communications channel; and
repeatedly transmitting by the integrated circuit the selected portion of status information maintained for the other communications channel over the time-division multiplexed channel to the host.

6. The method of claim 1, wherein the repeatedly transmitting comprises transmitting the selected portion of status information over a Signaling and Control (SC) channel for a General Circuit Interface (GCI).

7. The method of claim 1, comprising:
performing by the integrated circuit one or more of battery, overvoltage, ringing, supervision, codec, hybrid, and test (BORSCHT) functions for the communications channel.

8. An apparatus comprising:
circuitry to maintain status information for a communications channel;
circuitry to select a portion of the status information maintained for the communications channel; and
circuitry to transmit repeatedly the selected portion of status information over a time-division multiplexed channel to a host.

9. The apparatus of claim 8, comprising circuitry to receive from the host one or more commands identifying the portion of status information to be selected.

10. The apparatus of claim 8, wherein the circuitry to select a portion of the status information is to select a predetermined number of status bits for the communications channel.

11. The apparatus of claim 8, wherein the circuitry to select a portion of the status information is to select one or more of interrupt status information, hook status information, ground key status information, and/or ring trip status information.

12. The apparatus of claim 8, comprising:
circuitry to maintain status information for another communications channel;
circuitry to select a portion of the status information maintained for the other communications channel; and
circuitry to transmit repeatedly the selected portion of status information maintained for the other communications channel over the time-division multiplexed channel to the host.

13. The apparatus of claim 8, wherein the circuitry to transmit repeatedly the selected portion of status information comprises General Circuit Interface (GCI) circuitry to transmit the selected portion of status information over a Signaling and Control (SC) channel.

14. The apparatus of claim 8, comprising circuitry to perform one or more of battery, overvoltage, ringing, supervision, codec, hybrid, and test (BORSCHT) functions for the communications channel.

15. A system comprising:
a subscriber line interface circuitry integrated circuit for coupling to a host; and
a plurality of linefeed interface integrated circuits for coupling to the subscriber line interface circuitry integrated circuit and to a plurality of subscriber loops,
wherein the subscriber line interface circuitry integrated circuit comprises circuitry to maintain status information for one or more of the subscriber loops, circuitry to select a portion of the maintained status information, and circuitry to transmit repeatedly the selected portion of status information over a time-division multiplexed channel to the host.

16. The system of claim 15, wherein the subscriber line interface circuitry integrated circuit comprises circuitry to receive from the host one or more commands identifying the portion of status information to be selected.

17. The system of claim 15, wherein the circuitry to select a portion of the status information is to select a predetermined number of status bits for a subscriber loop.

18. The system of claim 15, wherein the circuitry to select a portion of the status information is to select one or more of interrupt status information, hook status information, ground key status information, and/or ring trip status information.

19. The system of claim 15, wherein the circuitry to transmit repeatedly the selected portion of status information comprises General Circuit Interface (GCI) circuitry to transmit the selected portion of status information over a Signaling and Control (SC) channel.
